(19) United States
(12) Patent Application Publication
(10) Pub. No.: US 2015/0169853 A1
(43) Pub. Date: Jun. 18, 2015

(54) System and Process for Controlling A Portable Device

(71) Applicant: AVINASH VIJAI SINGH, MANORHAVEN, NY (US)

(72) Inventor: AVINASH VIJAI SINGH, MANORHAVEN, NY (US)

(21) Appl. No.: 14/569,403

(22) Filed: Dec. 12, 2014

Related U.S. Application Data
(60) Provisional application No. 61/916,766, filed on Dec. 16, 2013.

(51) Int. Cl. G06F 21/30

(52) U.S. Cl. CPC G06F 21/305

(57) ABSTRACT

There is disclosed a system process for controlling the authentication of a user with a device. The device can have a memory and a microprocessor. The process can comprise a series of steps such as setting user permissions on a device via a series of instructions sent to the processor and storing said user permissions in the memory of the device. Another step can include limiting access to a device to particular users of the device based upon the identity of the user. Another step can include limiting access to the device to particular users based upon the time of day of use of the device. Another step can include locking access to the device including locking functionality of at least one component of the device to prevent use outside of a time of day of use.

### CROSS REFERENCE TO RELATED APPLICATIONS

This application is a non-provisional application and hereby claims priority from U.S. provisional patent application Ser. No. 61/916,766 filed on Dec. 16, 2013 the disclosure of which is hereby incorporated herein by reference in its entirety.

### BACKGROUND

One embodiment of the invention relates to a system and process for controlling a portable device such as a telephone or a tablet using a unique set of codes so that different applications can be controlled based upon different user authentications.

There is a need for parents or other parties in authority to control the access to applications and to components of an electronic device. For example, if parents did not want their children using a portable phone for unauthorized purposes or during unauthorized times it would be hard to control the child's behavior without some application or device for controlling the use of the remote electronic device.

Therefore there is a need for a system and process that includes the ability to set timers for each of the applications or even for use of the entire device based upon login codes as well. The system and process can be used to control other electronic devices as well as simply the applications associated with the different electronic devices.

### SUMMARY

At least one embodiment of the invention relates to a system and process for controlling the use of a an application or machine such as a mobile telephone or a mobile electronic device application through the use of unique codes. In addition, at least one embodiment relates to a system and process for controlling these codes using different timers on each of these applications.

For example, there can be a system process for controlling the authentication of a user with a device. The device can have a memory and a microprocessor. The process can comprise a series of steps such as setting user permissions on a device via a series of instructions sent to the processor and storing these user permissions in the memory of the device. Another step can include limiting access to a device to particular users of the device based upon the identity of the user. Another step can include limiting access to the device to particular users based upon the time of day of use of the device. Another step can include locking access to the device including locking functionality of at least one component of the device to prevent use outside of a time of day of use. Another step can include limiting the use of applications or duration of use of the applications based upon the location of the device at the time of login or the location of the device at the time of use.

To control a remote device an application can be downloaded and then associated with a device. The controlling of the downloading of the device can be initiated by an administrator who controls whether a party can use the device. The administrator can require that this application or program is installed on the device before further access to the device is allowed.

In addition there is also a device which has internal switches which can be switched on or off based upon remote control from an administrator.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a schematic block diagram of the system for use with the process for setting various user permissions on a device such as a mobile device;

FIG. 2A is a schematic block diagram of the server side components for use with setting an application;

FIG. 2B is a schematic block diagram of the device side components for use which handles the application;

FIG. 3 is a flow chart for the process for setting up a user with a system;

FIG. 4 is a flow chart for the process for allowing a user to login and restricting access to particular features or applications on a device;

FIG. 5 is a flow chart for the process for allowing an administrator to set time limits or the time of the week for use of a device or particular applications for use with a user;

FIG. 6 is a flow chart for the login and restriction of applications and features after a particular time period or day or date;

FIG. 7 is a schematic block diagram of a switching layout for another embodiment;

FIG. 8 is a block diagram of the different devices that can be controlled by an administrator;

FIG. 9 is a view of a screen for controlling remote devices; and

FIG. 10 is a flow chart of another embodiment for controlling remote devices.

### DETAILED DESCRIPTION

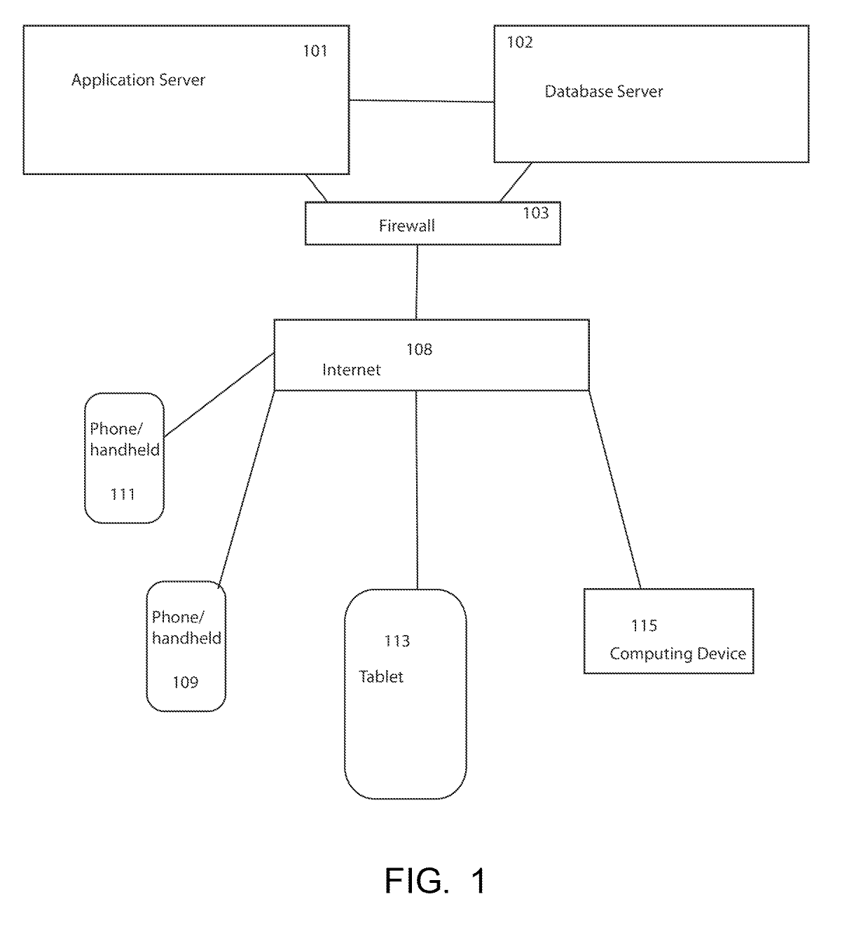

Turning now in detail to the drawings, FIG. 1 is a schematic block diagram of the system for use with the process for setting various user permissions on a device such as a mobile device. With this system there is an application server 101 and a database server 102. These two servers can be disposed behind a firewall such as firewall 103. Each of these servers can be in the form of a single stand-alone server or multiple servers distributed across a cloud or network. These servers are in communication with other computing devices through a network such as the world wide web or internet 108.

There can be multiple different devices such as mobile devices such as a phone or handheld device 111, a phone or handheld device 109, a tablet 113 or any other suitable type computing device 115 in communication through internet 108 to application server 101 and/or database server 102.

These servers such as application server 101 and/or database server 102 can be used to control the permissions on the different distributed computing devices 111, 109, 113, and 115. These servers are in at least one embodiment administrator devices, while the other devices such as devices 109, 111, 113, and 115 are remote or first devices. In at least one embodiment, the first device can be an administrator device as well, wherein an administrator can program in user settings on the device itself as well.

For example, user permissions can be controlled at the individual device level such as on phone/handheld 111 or application server 101 can for example, be used to control the access to the device as well as to particular applications on the device as well, wherein this control or authentication can be entirely different from that required from the stand alone device. The control can be control of both the operating system and the physical components themselves so that the instructions stored in memory can lock any one of the physical components as well.

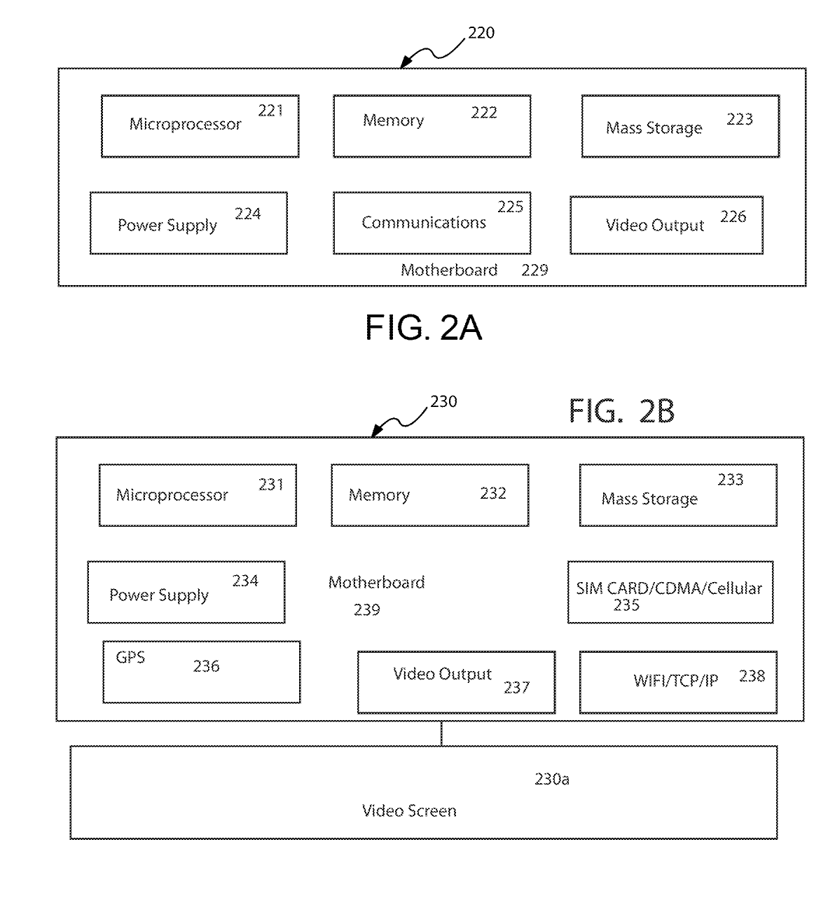

FIG. 2A is a schematic block diagram of the components that can be used in the computing device. For example, there is disclosed a motherboard 229, which is configured to house a microprocessor 221. In addition, also coupled to motherboard 229 is a memory 222, a mass storage 223, a power supply 224, a communications port 225, and an optional video output 226. Power supply 224 provides power output throughout the device and is used to provide power to all of these components. The microprocessor 221, memory 222, mass storage 223, communications 225, and video output 226 are all in communication with each other. Microprocessor 221 can be in the form of any suitable microprocessor such as an Intel based microprocessor or an AMD based microprocessor.

FIG. 2B is a schematic block diagram of the device side components for use which handles the application. These components are the type of components that can be typically found in the handheld or portable devices such as devices 109, 111, 113, and 115. All of the components in this device are similar such as microprocessor 231, vs. microprocessor 221 or memory 232 vs. memory 222, or mass storage 233 vs. mass storage 223, or motherboard 239 vs. motherboard 229 or power supply 234 vs. power supply 224 or video output 237 vs. video output 226. Essentially, the only features that are different with the portable devices is the presence of a GPS 236, a wifi transceiver 238, and a cellular transceiver and sim card 235. The video screen 230a is also integrated into the device as well.

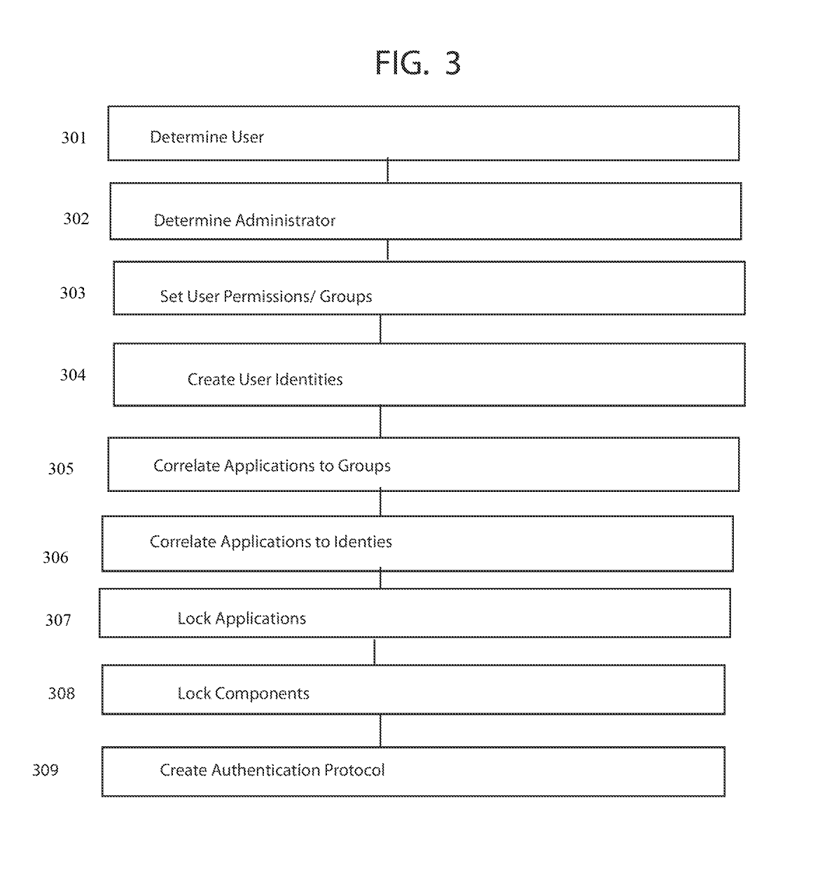

FIG. 3 is a flow chart for the process for setting up a user with a system. In this process, the process starts with step 301 wherein the system determines the user via an initial login. At this initial login, the administrator is determined such as in step 302 as well as other users. Next, in step 303 a user using the system such as using application server 101 and or an individual device such as device 111, can set user permissions based upon different groups of users.

Next, in step 303 the user can set permissions for users/and groups. For example, the user can set permissions for an administrator level such as in step 302, or other more restricted levels such as general user, or even below that such as emergency user. An emergency user is only allowed to make a telephone call using the portable device and is not granted access to the remainder of the applications in the device.

Next, in step 304 the user can create more user identities. Each user can have an identity which includes their personal information, as well as an association to a particular group based upon user permissions. Next, in step 305 the user can correlate different applications to different groups. For example, an administrator group would have access to multiple different applications, wherein a general user may have a more restricted access to different groups and an even more restricted user such as an emergency user would have even more restricted access to these applications. Each group can have multiple users associated with a particular group. If a user is in a particular group, than that particular group designation sets the maximum amount of freedom for a user in that group. The user can have even more restricted or customizable restrictions for their use in that group.

For example, in step 306 the user can correlate particular applications to identities. This can occur by restricting the use of different applications even further once a user is in a particular group. Thus, if an individual user is part of a general user group and the general user group allows these general users access to the following applications: calendar, telephone, email, photos, the administrator can restrict access for an individual user in that user group even further by for example restricting the rights to photos. All other users in that group would default to being able to use any of the above features however, that individual user would be even further restricted.

Next, in step 307, the administrator can lock these applications so that individual users can only access these applications if they have the requisite permissions. Next, and alternatively or in addition, the user can select which components to lock such as the device itself, the processor, the memory, the screen, or other object that are part of the remote computing device. The locking of the device can occur when the program takes control of the operating system to control individual components of a machine. Thus, the user can select any one of a GPS, microprocessor, screen, audio processor or output, video processor or output, memory etc. The user can then selectively disable this component so that it appears inactive to the user and cannot be enabled by the other components or programs in the system.

Next in step 309 the user/administrator can create an administration or authentication protocol wherein the user would log in either with a user id and a password or simply with a password. The password can be in the form of a series of characters, voice authentication, thumbprint, or fingerprint authentication or any other suitable type of authentication. Once these authentications have been created, users can then log in and have access to their applications.

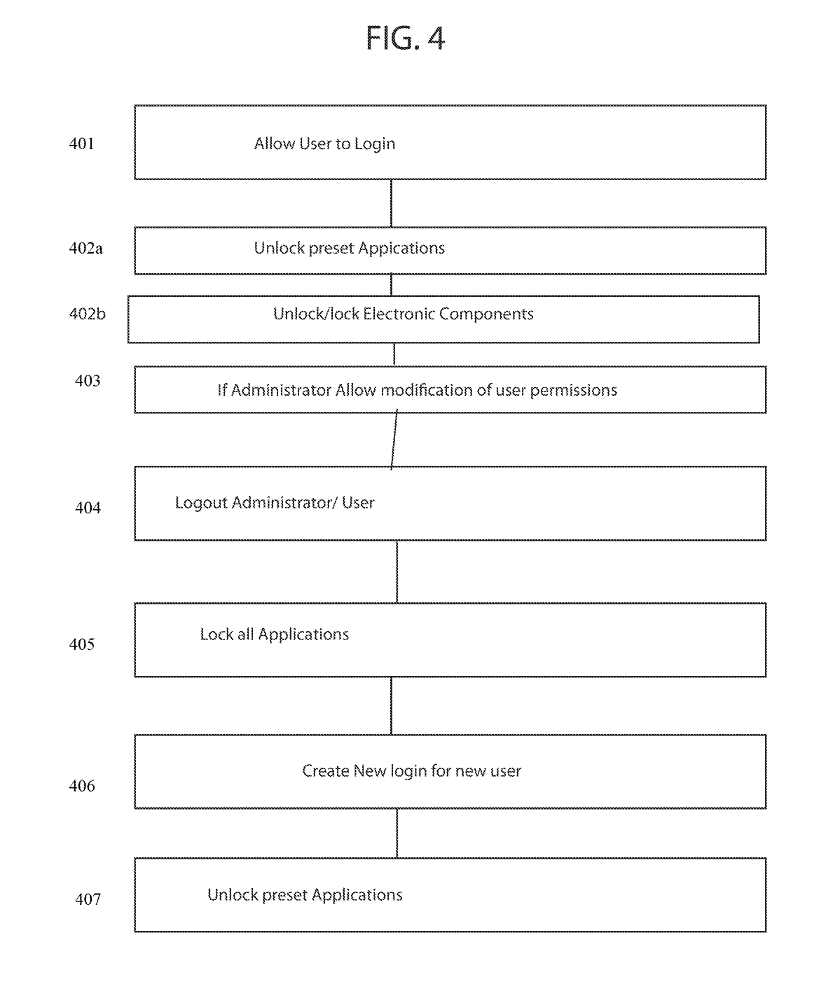

FIG. 4 is a flow chart for the process for allowing a user to login and restricting access to particular features or applications on a device. For example, in step 401 an individual user logs into the device and automatically the preset devices are unlocked in step 402a. Alternatively or in addition, the user/administrator can lock or unlock different electronic components associated with the remote device as well. As listed above, these different electronic components can be in the form of a screen, a microprocessor, audio components, video components, buttons, etc. If the user is an administrator, the user can in step 403 further adjust the permissions for an individual user to use particular applications. Next, if the user is an administrator the user can log out in step 404. Once the user is logged out again this locks all of the applications again. The user/administrator can also in step 406 create a new login for a new user, wherein as shown in FIG. 3 this can result in the creation of a new administrator, a new general user or a new emergency user. Once this user is created, once the user logs in again in step 407, the user can unlock all of the preset applications.

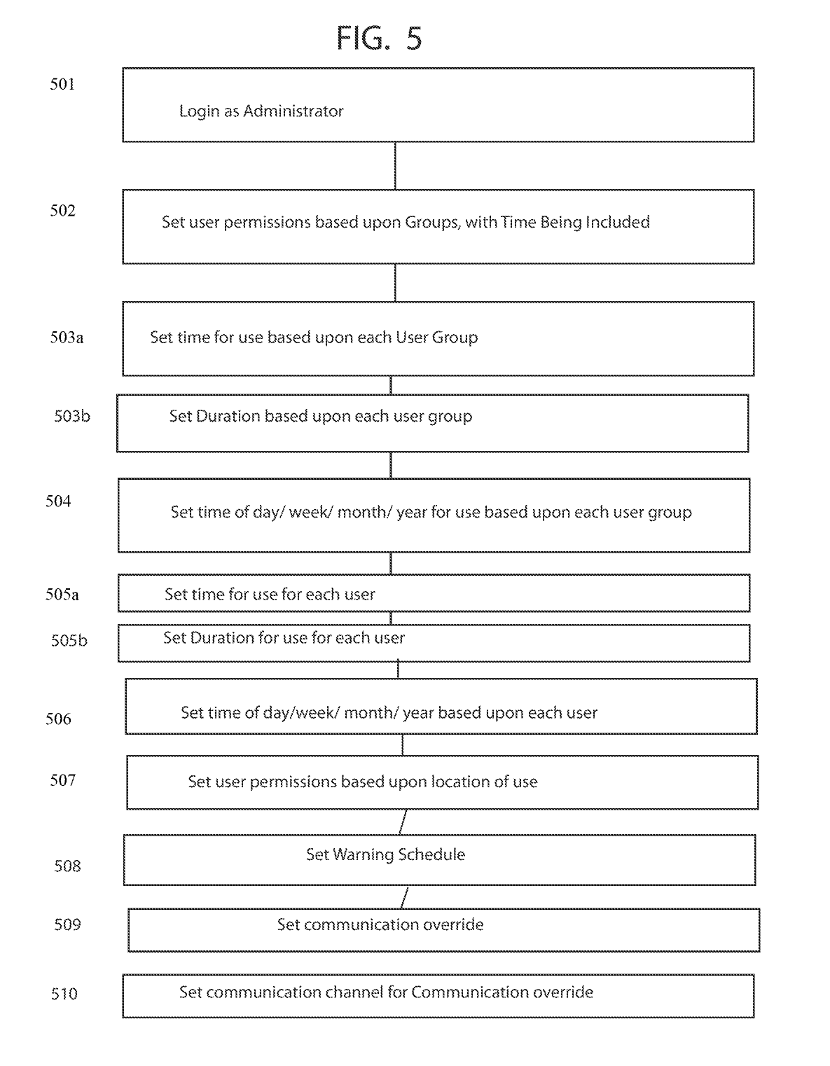

FIG. 5 shows the process for setting the time parameters for use of applications as well. For example, in step 501 the user can log in as an administrator and in step 502 set different user permissions based upon the groups and the time scope that the administrator wants a group to be included. Thus, in step 503a the administrator can set a time for use for each user in each group or institute universal time settings for each group. For example, if the administrator created a group called “kids” or “children” that administrator could restrict the time for use to 5-6 P.M. This way the users who may be kids or children and who log in under that group permissions would not be able to use any applications or any particular applications outside of this time range. Next, in step 503b the user/administrator can set the duration for use of a particular application. This duration for use can be such as ½ hour, one hour, two hours etc. The duration of use for each user can vary depending on the time of day as well as the location of each user. Thus, a particular user may have access to an application for ½ hour between 5-6 P.M. in their home but may only have access to the same application for 15 minutes between the hours of 6-7 P.M. at a location different from their home.

Next, in step 504 the administrator can set the time/day/week/month/year for use for each of the groups of users as described above. In addition, the administrator can in step 505a set these time permissions for each individual user under each group. As indicated above, with the group permissions in place, the subsequent individualized restrictions under this group are only more restrictive for each user in this group. Thus in step 505b the user/administrator can set the duration for use of the application(s) for each user which is distinct from the settings for a particular group as discussed in step 503b. Next, in step 506 the administrator can set the time/day/week/month/year for use for an individual user with these permissions being subject to, and only more restrictive than their associated group permissions.

Next, in step 507 the administrator can set user permissions based upon the location of use. This can be done so that the user can only use certain applications when that user is within a certain geographic range. This can be done either by identifying GPS coordinates, or geographic distances from a center point such as an address or location within a particular area such as a town, city, state or country. Thus, when the device is in this region, the GPS coordinates of the device being used can be matched to the GPS coordinates stored in the database which is either stored in the mobile device or phone or in the application server or the database server to determine whether to unlock a particular application.

Next, in step 509 the administrator can set a communication override which allows the user to communicate with the administrator to request a temporary override for the restrictions on use. This can be performed by the administrator remotely wherein the administrator can selectively unlock particular applications for the user. In addition the administrator/user can also select the communication channel for this communication such as via phone, email text, SMS, MMS or other type of communication to obtain additional permissions from the administrator. One means to perform this step is through a web screen wherein the user/administrator changes the user permissions on the fly.

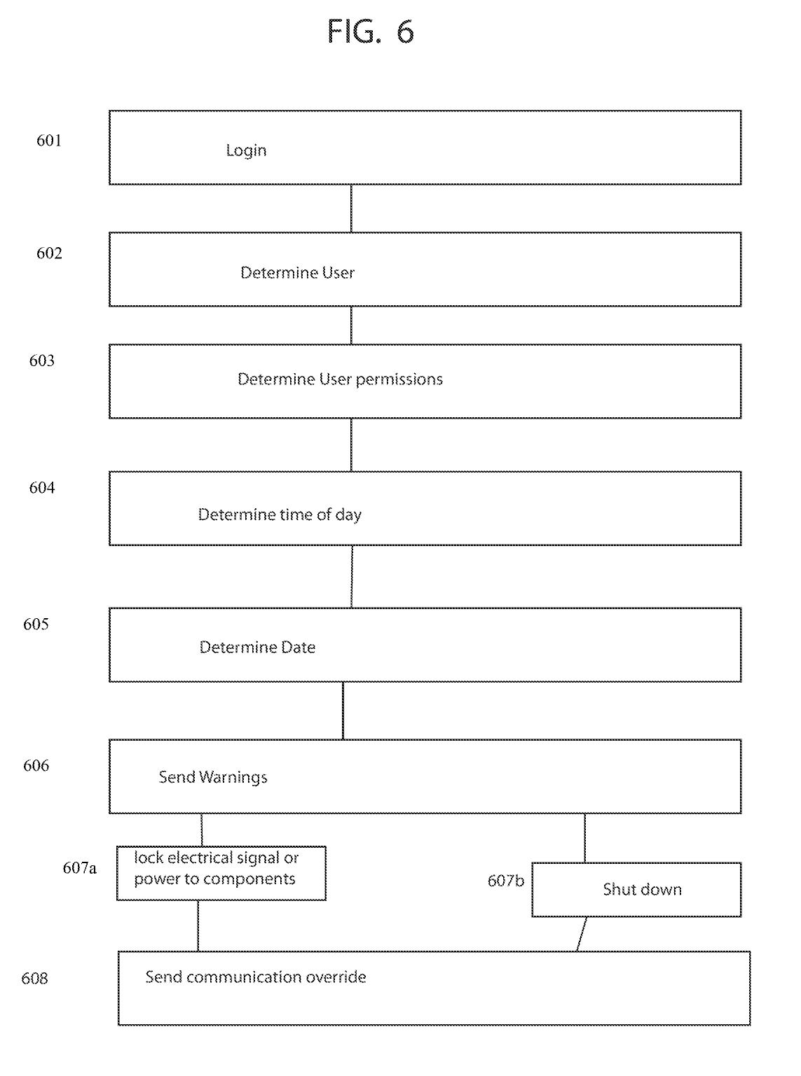

FIG. 6 is a flow chart for the login and restriction of applications and features after a particular time period or day or date. This process starts in step 601 wherein the user can login and then the system determines the type of user that is logged in, in step 602. Next, in step 603, the system can determine the user permissions for that user and unlock only the applications that are necessary for the user. Next, in step 604, the system can determine the time of day for the user, and in step 605 determine the date of user during use. In addition, if the time period is set as a running time from the start of the application, then the system can internally start a clock such as a countdown clock to restrict the use of an application for a predetermined period of time. These predetermined periods of time can vary based upon the different user/user permissions associated with that user and also based upon the time of day the date, month, or year. Next, in step 606 the system can post warnings for the user to tell the user that the application will be locked within a preset period of time. Next, in step 607 the system can shut down the application or even shut down the device or locking of the electrical signal or power. Alternatively, the user can request a communications override either before the application is shut down or after the application is shut down. This request for an override can be in the form of a text, an email or an automatic video chat or telephone call.

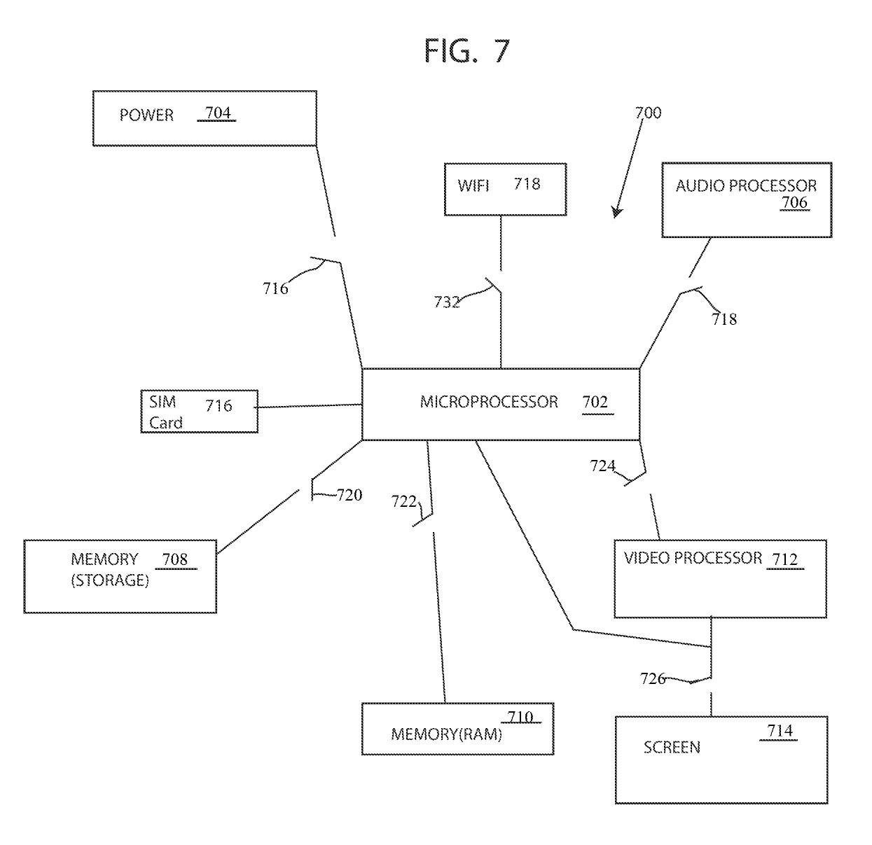

FIG. 7 is a schematic block diagram of a set of components for a remote device such as a telephone 700 or similar type device. This type of device can be in the form of a central microprocessor or CPU 702 in communication with other peripheral electronic components. These electronic components can include a power supply 704, a SIM card 716 for wireless communication, a memory storage unit 708 for storing data on a permanent or semi-permanent basis so as to serve as ROM. A memory or ram 710, a video processor 712, a screen 714 in communication with the video processor 712, and an audio processor 706.

Disposed between these components are switches such as switch 716 disposed between power supply 704 and processor 702, switch 732 disposed between WIFI 718 and microprocessor 702, switch 718 disposed between audio processor 706 and microprocessor 702, switch 724 disposed between video processor 712 and microprocessor 702, switch 726 disposed between video processor 712 and screen 714, switch 722 disposed between microprocessor 702 and memory 710, and switch 720 disposed between microprocessor 702 and memory storage device 708. The microprocessor 702, once it receives instructions from for example a communication from a server to WIFI 718 or from a server to SIM card 716 can then selectively switch any one of the above switches open so that these components lose both power and communication from microprocessor 702 thereby selectively disabling particular components. These components can then be remotely selectively re-activated by communication with microprocessor 702 which can then selectively close any one of the respective switches to connect the peripheral components together with microprocessor 702.

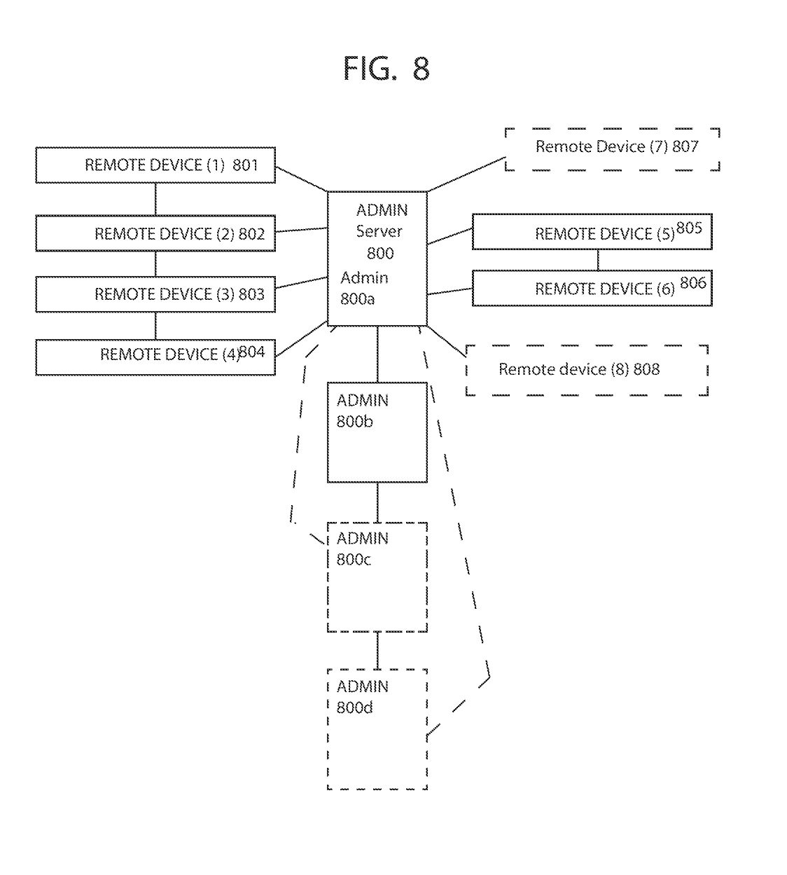

FIG. 8 is a layout of a network which can be used to remotely control different remote devices. For example there is an administrator server having an administrator 800 which can be in the form of any suitable server such as an application server in communication with a plurality of different remote devices such as remote device (1) 801, remote device (2) 802, remote device (3) 803, remote device (4) 804, remote device (5) 805, remote device (6) 806, remote device (7) 807, and remote device (8) 808.

Both remote device (7) and remote device (8) are configured as additional devices shown with dashed-dotted lines indicating that any number of remote devices such as any one from 1 through nearly infinite number of remote devices can be controlled by an administrative server 800 via at least one administrator. There are also a plurality of different administrators shown as well. These administrators can include a primary administrator 800a, or any number of secondary or tertiary, or additional administrators 800b, 800c, 800d etc. Thus if a first administrator is not available to control these electronic devices additional administrators can be used or relied upon to control the remote electronic devices.

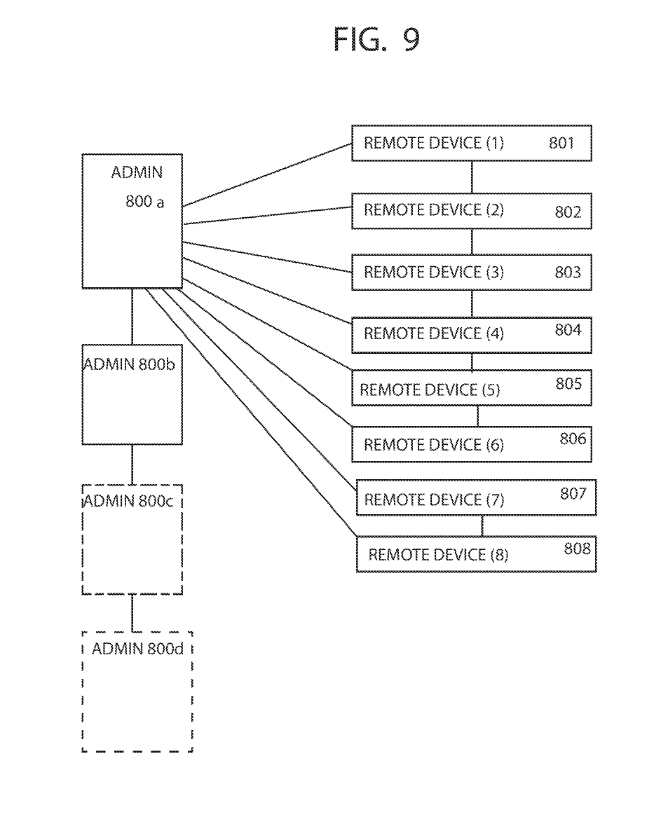

FIG. 9 shows a layout of a screen that can be used for controlling remote devices such as any one of remote devices 1-8 or more. The administrator who logs in such as any one of administrators 800a, 800b, 800c, 800d etc, and then control any one of the remote devices also shown in FIG. 8. The administrator can simply select a remote device such as remote device 1 and then selectively turn off any one of the applications stored on that device or turn off any one of the peripheral electronic components on that device as described above in FIG. 7. Thus the administrator is able to control both the applications and also the electronic components remotely from a central screen such as via a web screen.

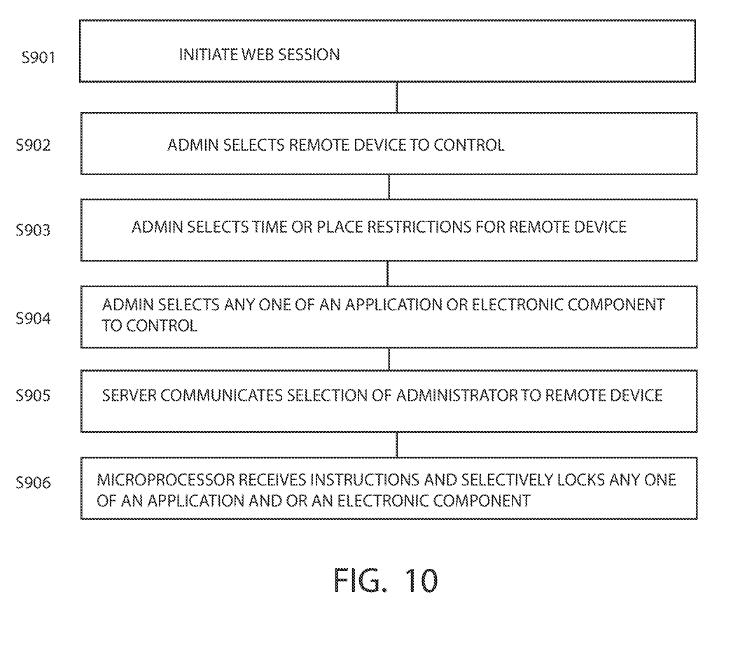

As shown in FIG. 10 thus, to take control of a first or a remote device the administrator device or server such as server 800 can initiate a web session in step S901, allow a user to communicate through the web session to select particular remote device to control in step S902. Next, the administrator in step S903 can select a time or place of restrictions for the remote device such as remote devices 801-808). Next, the administrator in step S904 can select any one of the application or electronic component in that particular remote electronic device to control. Next, in step S905 the server can communicate this selection of the administrator to the selected remote device. This step can be performed simultaneously for multiple remote electronic devices at the same time. Thus, through simultaneous initiated web sessions or communication sessions, the administrative server can communicate these instructions to a plurality of different remote devices simultaneously through simultaneously initiated web sessions and connections with a plurality of different remote devices. As disclosed in the above embodiments the remote devices or first devices 801-808 can also serve as administrator devices and be programmed for selective use directly thereon. The steps or instructions that are stored on the administrative device(s) can also be stored as machine readable program code stored on a medium such as a memory (RAM) or memory storage unit which when uploaded to a microprocessor such as microprocessor 221, 231, or 702, allows the device to perform the functions of the code.

Accordingly, while at least one embodiment of the present invention has been shown and described, it is obvious that many changes and modifications may be made thereunto without departing from the spirit and scope of the invention.

What is claimed is:

1. A process for controlling an authentication of a user with a remote device having a memory and a microprocessor, the process comprising:
a) automatically setting user permissions on a first device via a series of instructions sent from at least one administrator device to a microprocessor on said first device and storing said user permissions in the memory of the first device;
b) automatically limiting access to said at least one first device to particular users of the device based upon an identity of the user and in response to the instructions sent by said administrator device;
c) automatically limiting access to the device to particular users based upon a time of day of use of the first device based upon instructions sent from the at least one administrator device; and
d) automatically locking access to the first device including locking functionality of at least one component of the first device to prevent use outside of a time of day of use in response to the instructions sent from the administrator device and stored in the memory.

2. The process as in claim 1, wherein said step of setting user permissions includes setting a plurality of different user groups with at least two different user groups having at least two different levels of permission.

3. The process as in claim 1, wherein said step of setting user permissions includes setting user permissions based upon individual user identities.

4. The process as in claim 1, wherein said step of setting a time of day includes determining which applications to lock based upon the user authentication and the time of day that the user logged in.

5. The process as in claim 1, wherein said step of setting a time of day includes a duration for use of each application and for each user based upon a time of day for that user.

6. The process as in claim 1, further comprising the step of sending a warning to the user based upon an amount of time that the user has left on an application and/or device.

7. The process as in claim 1, wherein said step of locking access to at least one component comprises locking access to the microprocessor of the remote device.

8. The process as in claim 1, wherein said step of locking access to at least one component comprises locking access the memory of the remote device.

9. The process as in claim 1, wherein said step of locking access to at least one component comprises locking access to at least one screen of the first device.

10. The process as in claim 1, wherein said step of locking access to at least one component comprises locking access to at least one of audio output, video output, GPS, or buttons of the first device.

11. A process for controlling an authentication of a user with a device having a memory and a microprocessor, the process comprising:
a) setting user permissions on an administrator device for a first device via a series of instructions sent to the microprocessor of the first device and automatically storing said user permissions in the memory of the first device;
b) automatically limiting access to the first device to particular applications based upon a user identity for a particular user and allowing a limited time for use of other particular applications for at least one user of a plurality of users; and
c) automatically locking access to the first device including locking functionality of at least one component of the first device to prevent use outside of a preset period of time based upon the set user permissions set on the administrator device.

12. The process as in claim 11, further comprising the step of limiting a user access to the first device based upon pre-set user permissions based upon a time of day.

13. The process as in claim 11, further comprising the step of limiting a user access to the first device based upon pre-set user permissions based upon a date.

14. The process as in claim 11, further comprising the step of limiting a user access to the first device based upon pre-set user permissions based upon a length of time of use of an application on the first device.

15. The process as in claim 11, further comprising the step of limiting a user access to the first device based upon pre-set user permissions based upon a location of the user at a time of use of the first device.

16. The process as in claim 11, further comprising allowing the user to request an override of the user's permissions on the first device by communicating with an administrator user of the first device.

17. The process as in claim 11, wherein an administrator can set permissions on the first device itself, and wherein the first device and the administrator device are the same device.

18. The process as in claim 11, wherein an administrator can set permissions for the first device on said separate administrator device which controls authentication for first device and wherein said first device and said administrator device are separate devices.

19. The process as in claim 11, further comprising the step of communicating from a central server to a remote device instructions to switch at least one switch on said remote device to switch off communication of at least one of the following components:
a) a power supply;
b) a wifi transceiver;
c) an audio processor;
d) a memory storage unit;
e) a memory; and
f) a video processor;

20. A system for controlling a remote electronic device comprising:
a) at least one first computer;
b) at least one remote electronic device which is in communication with said at least one first computer wherein said remote electronic device comprises:
i) at least one microprocessor;
ii) at least one audio processor;
iii) at least one power supply;
iv) at least one memory storage unit;
v) at least one memory;
vi) at least one screen;
vii) at least one video processor;
viii) a plurality of switches disposed between said at least one microprocessor and at least one of said audio processor, said power supply, said at least one memory storage unit; said at least one memory; and said at least one video processor, wherein upon an instruction from said at least one first computer said microprocessor selectively switches off at least one of said microprocessor, said audio processor, said at least one power supply, said at least one memory storage unit, said at least one memory, said at least one video processor.
